(19) United States
(12) Patent Application Publication
(10) Pub. No.: US 2003/0022661 A1
(43) Pub. Date: Jan. 30, 2003

(54) Downloading software over the air for implementation of air interface protocols

(76) Inventor: Jose Guterman, Calgary (CA)

Correspondence Address: Timothy N. Trop, TROP, PRUNER & HU, P.C., 8554 KATY FWY, STE 100, HOUSTON, TX, 77024-1805, US

(21) Appl. No.: 09/899,682

(22) Filed: Jul. 5, 2001

(51) Int. Cl. H04M 3/00

(52) U.S. Cl. 455/418; 455/423

(57) ABSTRACT

A flexible air interface protocol may be established by providing mobile units with less than the entire air interface protocol software. Additional interface software may then be supplied over-the-air when the mobile unit links with a particular base station. Particular base stations may have interface software appropriate for given localities. In addition, some base stations may include specification enhancements. Still other base stations may include interface software applicable in particular situations. In some embodiments of the present invention, the interface software may be supplied in response to a triggering event.

### BACKGROUND

This invention relates generally to wireless communication systems.

In wireless communication systems a base station may communicate with a plurality of wireless mobile units. Calls initiated by the mobile units are forwarded through the base stations to their intended recipients. Incoming calls are provided to the mobile units from the base station.

Currently, a variety of air interface protocols have been developed by various standards bodies. In different areas of the world, one or more of the standards may apply. Generally, the idea of the standards is that only certain parameters of a protocol can be configured or changed on a per system, per user or per cell basis. This ensures that within systems that follow the standard, compatibility will rule.

However, a number of problems arise with such standards that attempt to enforce protocols among a variety of different service and system providers. If it becomes apparent that it would be desirable to change such a standard, it is difficult to do so because those standards are effectively fixed in a large amount of hardware. Thus, base stations and mobile units that were purchased before the standard change are difficult to retrieve and update.

When actually applied, the air interface protocols may be found to have particular problems. Updating to improve these problems with legacy systems is difficult. Moreover, when one equipment or service provider realizes that a problem exists with respect to the air interface protocol, at least as applied to that hardware or service provider, it is difficult to enact the standard change because agreement may be required among a large number of participants in the standard setting group. There is still the problem of backward compatibility with legacy hardware and software. In addition, even if all of these hurdles are overcome, some amount of time may be required to implement and apply the changes.

In some cases, air interface protocols that were intended to be applicable generally across a wide geographic area may be inapplicable or hard to apply in certain geographic areas. For example, topography and population density may adversely impact standards intended to be all encompassing. Thus, specific regions may wish to alter the air interface protocol standards but may be inhibited from doing so because the air interface protocol is incorporated into base station and mobile unit hardware and software that is supplied by suppliers outside the affected region. Thus, hardware and software providers may provide software and hardware that is protocol compliant, thereby precluding specific localities from appropriately altering those protocols.

Another reason to consider configuring or changing protocols on a per system, per user or per cell basis is that specifications may not be perfect and multiple implementations may have compatibility problems. Field tests and validation procedures may be needed to remove compatibility problems. Again, there may be the desire in specific circumstances to alter air interface protocols. But again, because these protocols may be imbedded into the only available equipment, it may be difficult to adapt to specific needs of particular systems, users, or cells.

Thus, there is a need for a way to implement air interface protocols in a more flexible and dynamic fashion.

### BRIEF DESCRIPTION OF THE DRAWINGS

FIG. 1 is a flow chart for software to download air interface protocol updates in accordance with one embodiment of the present invention;

FIG. 2 is a flow chart for software for an alternative embodiment of the present invention;

FIG. 3 is a flow chart for software for applying the updated software in accordance with one embodiment of the present invention; and

FIG. 4 is a schematic depiction of a mobile unit in accordance with one embodiment of the present invention.

### DETAILED DESCRIPTION

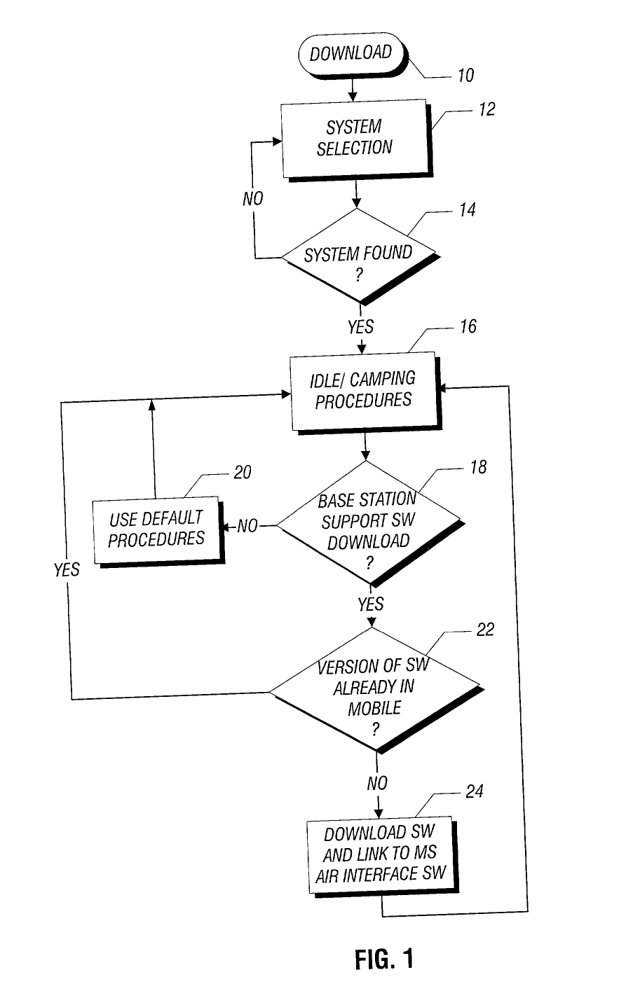

Referring to FIG. 1, the download software 10, in accordance with one embodiment of the present invention, may be utilized to allow over the air downloading of interface software. The term “interface software” is intended to refer generally to any modification of air interface protocols already stored on a mobile unit or base station or even to substantially the entire protocol. Thus, the interface software may be a new version of existing software in one embodiment of the present invention. In addition, there may be particular protocols suitable for particular geographic areas. In other words, there may variations on manufacturer supplied protocols to adapt to specific situations in particular geographic localities. As still another example, the interface software may improve performance in particular situations where compatibility problems arise.

In some embodiments, by applying the interface software over the air or through the wireless system itself, mobile units may be provided with software needed to operate at a particular time, in a particular location or under particular circumstances. Any time the mobile unit arrives within a cell with peculiar needs, the software may be provided to that unit to operate most effectively under particular circumstances. Thus, it may be appreciated that a relatively dynamic system may be provided which is adaptable to a wide variety of changing situations. At the same time, manufacturers of equipment and providers of services will not in any way be adversely affected because those services and equipment may still be provided in a standardized fashion.

In accordance with one embodiment of the present invention, initially the download software 10 implements system selection as indicated in block 12. When an appropriate system is identified as indicated in diamond 14, idle or camping procedures may be implemented as indicated at block 16.

During idle or camping, a check at diamond 18 determines whether the local base station supports update software downloads. If so, a check at diamond 22 determines whether a version of the available software is already stored on the mobile unit as indicated in diamond 22. If so, the flow simply cycles. Thus, the mobile unit determines whether it has the appropriate interface software from a given base station.

If the version of the software provided by the local base station is not already stored in the mobile unit, then the interface software may be downloaded and linked into the existing protocol (if any) already stored in the mobile unit.

In one embodiment of the present invention, all mobile units are provided with an updatable set of basic air interface protocols. To the greatest possible extent, these air interface protocols may be the minimum needed to operate the system in a compatible way. Then interface software may be provided in specific situations as needed. In addition, a set of default parameters may be provided so that if the mobile unit only has the basic set of air interface protocols and a given base station does not support over the air software updates, the mobile unit may still operate in a fashion compatible with existing air interface protocols.

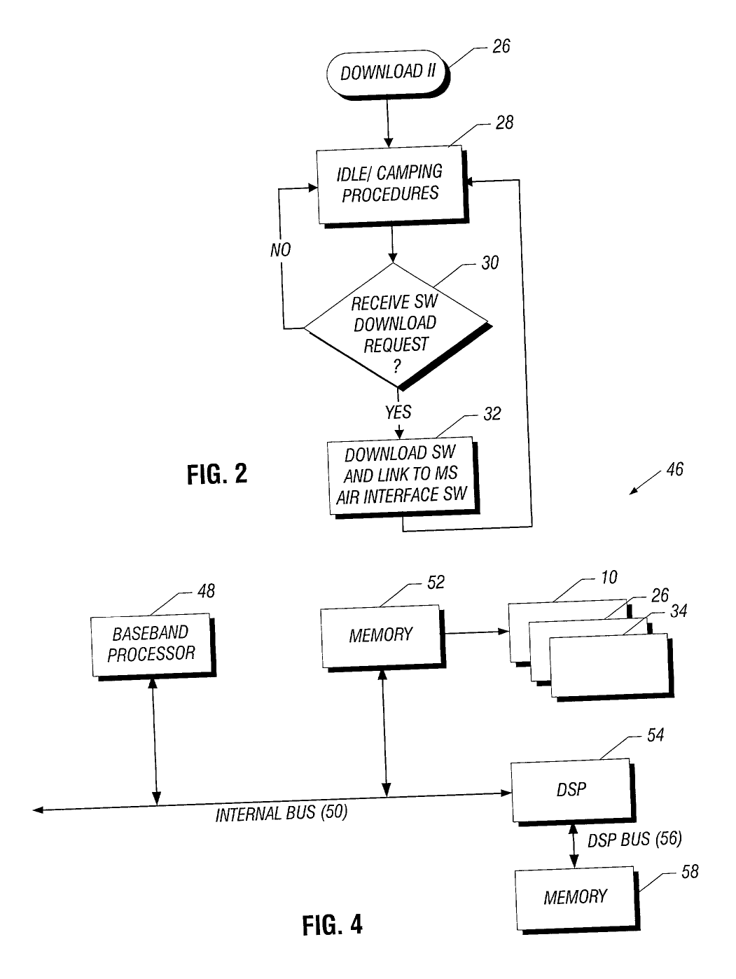

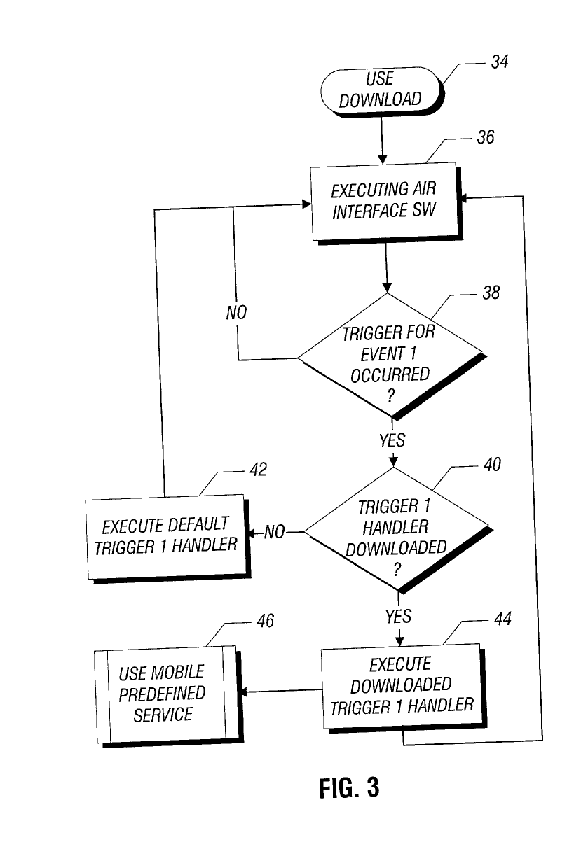

In the embodiment of FIG. 1, the interface software is automatically pulled from the base station by the mobile unit. In other embodiments of the present invention, it may be desirable to push interface software to the mobile unit. Referring to FIG. 2, the download software 26 in the idle or camping mode, as indicated in block 28, checks to determine whether a software download request has been received from a base station as indicated in diamond 30. In other words, the mobile unit checks to see whether the base station has determined that additional protocols are needed or appropriate in a particular base station area. For example, a particular code received from a base station may trigger software on the mobile unit to actually request the interface software. In addition, a particular base station may have a database including a look-up table of particular mobile units that may operate more efficiently with a particular interface software. As still another alternative, upon communicating with the base station, the base station may provide a list of available interface software and the software on the mobile unit may then determine whether the mobile unit will accept the interface software.

If a request for a software download has been received by the mobile unit, then the appropriate interface software is downloaded from the base station as indicated in block 32.

The downloaded interface software may be used as indicated by the software 34. In block 36, the mobile unit is executing the air interface software. Thus, the mobile unit in this situation is utilizing the basic air interface protocol that was provided with the mobile unit in one embodiment.

A trigger for an event may be detected as indicated in diamond 38. If so, a check at diamond 40 determines whether the trigger handler has been downloaded. In this case, the basic software provided with the mobile unit is aware of a particular trigger event and the software knows that if that trigger event occurs, the software capability to handle that event may be acquired from the base station.

Thus, in one embodiment, a minimum set of protocols may be provided to ensure basic functionality. The remaining implementations may be downloaded once the mobile establishes a link connection with a given base station. The download can be initiated by the base station or by the mobile. Instead of defining the procedures that the mobile should implement, a set of services and trigger events may be defined for interfacing to the system-provided software. Then the mobile simply implements a set of primitive services that may be used by the system implementation of some mobile functions.

If the handler has already been downloaded, it may be executed, as indicated in block 44, and the mobile may use the predefined services as indicated in block 46. Conversely, if it has not been downloaded, a default trigger handler 42 may be executed. Alternatively, if time permits, the handler may be downloaded at the time when the need arises, in another embodiment of the present invention.

Referring to FIG. 4, an architecture for a mobile unit 46 in accordance with one embodiment of the present invention includes an internal bus 50 that permits communications between a baseband processor 48 and a digital signal processor (DSP) 54. A memory 52 may store the software 10, 26 and 34 as well as any interface software in one embodiment of the present invention. The DSP 54 may communicate over a bus 56 with a memory 58 in one embodiment of the present invention. Of course, a wide variety of other architectures may be used.

Thus, in some embodiments of the present invention, air interface protocol specification updates may be instantly applied. Specific situations may be rectified for particular localities by providing update software as needed in those localities. In some embodiments, the update software needed to operate in a particular locality may only be provided from a base station when a mobile unit is in that locality. In addition, compatibility problems in particular situations may be rectified by providing the needed update software as those situations arise. Alternatively, substantially the entire interface software may be downloaded upon connection to a base station.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling a mobile unit to access a base station; and
downloading interface software when the mobile unit accesses the base station.

2. The method of claim 1 including initiating the downloading from the base station.

3. The method of claim 1 including initiating the downloading by the mobile unit.

4. The method of claim 1 including detecting a triggering event and in the response to the detection of said triggering event, determining whether interface software has been downloaded.

5. The method of claim 4 wherein if interface software has not been downloaded, downloading the interface software.

6. The method of claim 4 wherein if the interface software has not been downloaded, using default software.

7. The method of claim 1 wherein downloading interface software includes downloading new versions of an air interface protocol.

8. The method of claim 1 wherein downloading interface software includes downloading software suitable for a particular geographic area.

9. The method of claim 1 wherein downloading interface software includes downloading software to address interface compatibility problems.

10. The method of claim 1 including downloading an update to an air interface protocol.

11. The method of claim 1 including downloading substantially the entire air interface protocol.

12. An article comprising a medium storing instructions that enable a processor-based system to:
enable a mobile unit to access a base station; and
automatically download interface software when the mobile unit accesses the base station.

13. The article of claim 12 further storing instructions that enable the interface software to be downloaded at the initiation of the base station.

14. The article of claim 12 further storing instructions that enable the processor-based system to initiate the downloading of the interface software.

15. The article of claim 13 further storing instructions that enable the processor-based system to detect a triggering event and in response to the detection of the triggering event, determine whether interface software has been downloaded.

16. The article of claim 15 further storing instructions that enable the processor-based system to download the interface software if the interface software has not already been downloaded.

17. The article of claim 15 further storing instructions that enable the processor-based system to use default interface software if the interface software has not been downloaded.

18. The article of claim 12 further storing instructions that enable the processor-based system to download new versions of an air interface protocol.

19. The article of claim 12 further storing instructions that enable the processor-based system to download software suitable for a particular geographic area.

20. The article of claim 12 further storing instructions that enable the processor-based system to download interface software to address an interface compatibility problem.

21. The article of claim 12 further storing instructions that enable the processor-based system to download substantially the entire air interface protocol.

22. The article of claim 12 further storing instructions that enable a processor-based system to download an update to an air interface protocol.

23. A wireless device comprising:
a processor; and
a storage coupled to said processor, said storage storing instructions to automatically download interface software when the device accesses a base station.

24. The device of claim 21 wherein said device is a wireless telephone.

25. The device of claim 21 wherein said processor receives an interface software download from the base station.

26. The device of claim 21 wherein said processor detects a triggering event in response to the detection of the triggering event determines whether interface software has been downloaded.

27. The device of claim 22 wherein said processor downloads the interface software if the interface software has not already been downloaded.
